(19) United States
(12) Patent Application Publication
(10) Pub. No.: US 2015/0055227 A1
(43) Pub. Date: Feb. 26, 2015

(54) IMAGING LENS ASSEMBLY

(71) Applicant: Ability Opto-Electronics Technology Co., LTD., Taichung City (TW)

(72) Inventor: Hung-Kuo Yu, Taichung City (TW)

(73) Assignee: Ability Opto-Electronics Technology Co., LTD., Taichung City (TW)

(21) Appl. No.: 14/460,475

(22) Filed: Aug. 15, 2014

(30) Foreign Application Priority Data
Aug. 20, 2013 (TW) 102215589

(51) Int. Cl. G02B 13/00

(52) U.S. Cl. CPC G02B 13/0035
USPC 359/716

(57) ABSTRACT

An imaging lens assembly includes first, second and third optical lens elements that are arranged sequentially from an object side to an image side along an optical axis and that respectively have positive, negative and positive refractive powers, and a fixed aperture stop that is disposed between the object side and the second optical lens element. The imaging lens assembly satisfies the optical conditions of: |f1/f|>0.85 and |f2/f|>3.0, in which, f represents a focal length of the imaging lens assembly, and f1 and f2 represent focal lengths of the first optical lens element and the second optical lens element, respectively.

### CROSS-REFERENCE TO RELATED APPLICATION

This application claims priority of Taiwanese Application No. 102215589, filed on Aug. 20, 2013.

### BACKGROUND OF THE INVENTION

1. Field of the Invention

The present invention relates to an imaging lens assembly.

2. Description of the Related Art

An imaging lens set is generally adopted in an electronic device, such as a mobile phone, a notebook computer or a webcam. With the rapid development of technology, these electronic devices are designed to be increasingly lighter, thinner, shorter and smaller, and to have better performance. Therefore, an image sensor for the imaging lens set, for example, a charge-coupled device (CCD) or a complementary metal-oxide-semiconductor (CMOS), should be made to have higher resolving power. Moreover, the imaging lens set for the electronic devices should be made correspondingly smaller as well.

### SUMMARY OF THE INVENTION

Therefore, an object of the present invention is to provide an imaging lens assembly that has an alternative three-lens structure.

Accordingly, an imaging lens assembly includes an optical lens set and a fixed aperture stop.

The optical lens set includes first, second and third optical lens elements that are arranged sequentially from an object side to an image side along an optical axis of the imaging lens assembly.

The first optical lens element has a positive refractive power near the optical axis. The first optical lens element has an arched object-side surface that faces the object side, and an arched image-side surface that faces the image side. The second optical lens element has a negative refractive power near the optical axis. The second optical lens element has an arched object-side surface that faces the object side, and an arched image-side surface that faces the image side. The third optical lens element has a positive refractive power near the optical axis. The third optical lens element has an arched object-side surface that faces the object side, and an arched image-side surface that faces the image side.

The fixed aperture stop is disposed between the object side and the second optical lens element.

The imaging lens assembly satisfies the following optical conditions:

|f1/f|>0.85, and

|f2/f|>3.0

in which, f represents a focal length of the imaging lens assembly, and f1 and f2 represent focal lengths of the first optical lens element and the second optical lens element, respectively.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view of a first preferred embodiment of an imaging lens assembly according to the present invention;

FIG. 2 shows a table of optical parameters for optical lens elements, a fixed aperture stop, a filter and a cover glass of the first preferred embodiment;

FIG. 3 shows a table of parameters for aspheric surfaces of the first preferred embodiment;

FIG. 4 is a simulation result of optical astigmatism of the first preferred embodiment;

FIG. 5 is a simulation result of optical distortion of the first preferred embodiment;

FIG. 6 is a simulation result of spherical aberration of the first preferred embodiment;

FIG. 7 is a schematic view of a second preferred embodiment of an imaging lens assembly according to the present invention;

FIG. 8 shows a table of optical parameters for optical lens elements, a fixed aperture stop, a filter and a cover glass of the second preferred embodiment;

FIG. 9 shows a table of parameters for aspheric surfaces of the second preferred embodiment;

FIG. 10 is a simulation result of optical astigmatism of the second preferred embodiment;

FIG. 11 is a simulation result of optical distortion of the second preferred embodiment;

FIG. 12 is a simulation result of spherical aberration of the second preferred embodiment; and

FIG. 13 shows a table of optical parameters for the first and second preferred embodiments.

### DETAILED DESCRIPTION OF THE PREFERRED EMBODIMENTS

Before the present invention is described in greater detail, it should be noted that like elements are denoted by the same reference numerals throughout the disclosure.

### First Preferred Embodiment

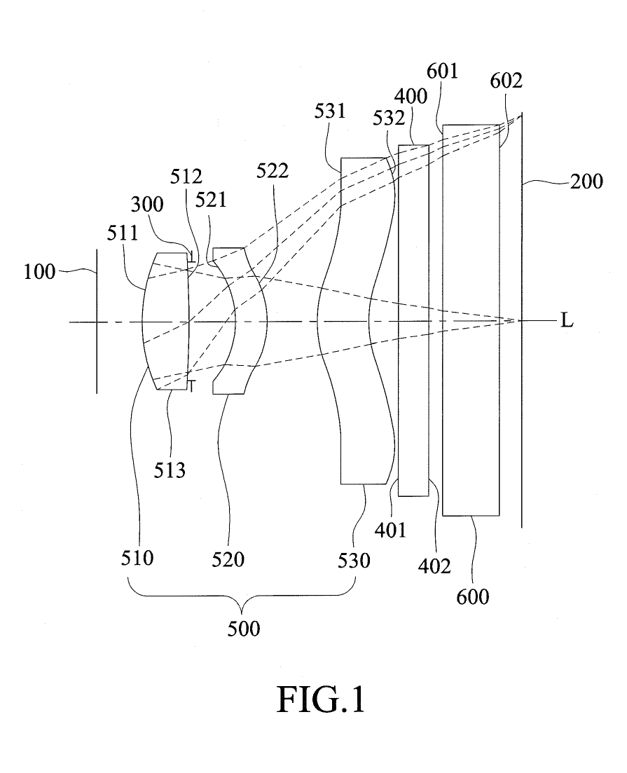

Referring to FIG. 1, a schematic view of a first preferred embodiment of an imaging lens assembly according to the present invention is shown to include an optical lens set 500, a fixed aperture stop 300, a filter 400 and, optionally, a cover glass 600, and is capable of forming an image on an image side (imaging plane) 200.

The optical lens set 500 includes first, second and third optical lens elements 510, 520, 530 that are arranged sequentially from an object side 100 to the image side 200 along an optical axis (L) of the imaging lens assembly. The image is formed on the imaging plane 200 by passage of light from the object side 100 through the optical lens set 500.

The first optical lens element 510 has an arched object-side surface 511 that faces the object side 100 and that has a convex segment near the optical axis (L), and an arched image-side surface 512 that faces the image side 200 and that has a concave segment near the optical segment (L) such that the first optical lens element 510 has a positive refractive power near the optical axis (L). The second optical lens element 520 has an arched object-side surface 521 that faces the object side 100 and that has a concave segment near the optical axis (L), and an arched image-side surface 522 that faces the image side 200 and that has a convex segment near the optical segment (L) such that the second optical lens element 520 has a negative refractive power near the optical axis (L). The third optical lens element 530 has an arched object-side surface 531 that faces the object side 100 and that has a convex segment near the optical axis (L), and an arched image-side surface 532 that faces the image side 200 and that has a concave segment near the optical axis (L) such that the third optical lens element 530 has a positive refractive power near the optical axis (L).

Moreover, the first optical lens element 510 has a peripheral surface 513 that interconnects the object-side surface 511 and the image-side surface 512. The image-side surface 512 of the first optical lens element 510 in this preferred embodiment has at least one inflection point between the optical axis (L) and the peripheral surface 513.

In this preferred embodiment, at least one of the object-side surfaces 511, 521, 531 and the image-side surfaces 512, 522, 532 of the first, second and third optical lens elements 510, 520, 530 is aspheric, and satisfies the following equation:

$$z = \frac{{ch}^{2}}{1 + {[ 1 - ( k + 1 ) {c}^{2} {h}^{2} ]}^{0.5}} + A {h}^{4} + {Bh}^{6} + {Ch}^{8} + {Dh}^{10} + {Eh}^{12} + {Fh}^{14} + {Gh}^{16} + {Hh}^{18} + {Jh}^{20} + … , \qquad ( eq 1 )$$

in which, z is the z-component of the displacement of the aspheric surface from the vertex of the aspheric surface along the optical axis, at a distance h from the optical axis; k is a conic constant; c is the reciprocal of a radius of curvature; and A, B, C, D, E, F, G, H and J, etc. are aspheric coefficients.

The fixed aperture stop 300 in this preferred embodiment is disposed between the first and second optical lens elements 510, 520, more particularly, on the image-side surface 512 of the first optical lens element 510, but may be disposed in any place between the object side 100 and the second optical lens element 520 in other embodiments of the present invention.

The filter 400 has an object-side surface 401 that faces the object side 100 and an image-side surface 402 that faces the image side 200. The filter 400 in this preferred embodiment is a band-pas s optical lens element and is disposed between the third optical lens element 530 and the image side 200.

The cover glass 600 has an object-side surface 601 that faces the object side 100 and an image-side surface 602 that faces the image side 200. The cover glass 600 in this preferred embodiment is disposed between the filter 400 and the image side 200. The image is formed on the image side 200 by passage of light from the object side 100 through the optical lens set 500, the fixed aperture stop 300, the filter 400 and the cover glass 600.

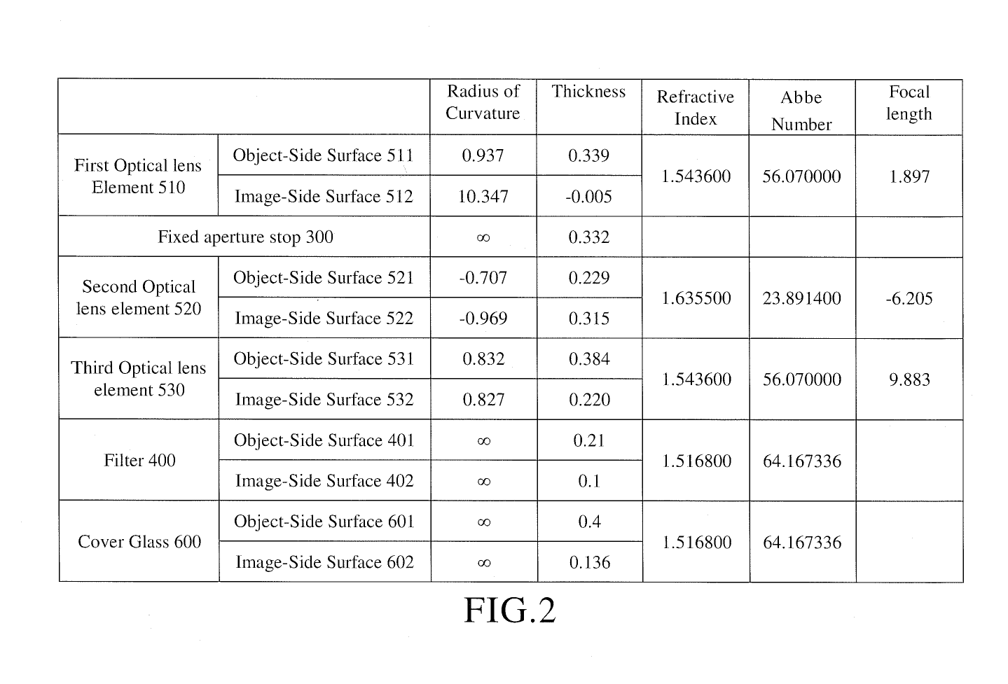

FIG. 2 shows a table of optical parameters for the optical lens elements 510, 520, 530, the fixed aperture stop 300, the filter 400 and the cover glass 600 of the first preferred embodiment of the imaging lens assembly according to the present invention. Specifically, the optical parameters include radius of curvature, thickness, refractive index, Abbe number and focal length.

The imaging lens assembly satisfies the following optical conditions:

|f1/f|>0.85 (eq2), and

|f2/f|>3.0 (eq3),

in which, f represents a focal length of the optical lens set 500, and f1 and f2 represent focal lengths of the first optical lens element 510 and the second optical lens element 520, respectively.

The imaging lens assembly in this preferred embodiment further satisfies the following optical conditions:

HFOV>35 degrees (eq4),

0.5<ct3/ct1<4 (eq5),

0.85<|f1/f|<1.1 (eq6),

3.0<|f2/f|<5.0 (eq7),

0<T12/f<1.0 (eq8),

0<R1/R2<0.5 (eq9), and

0<f3/f1<10 (eq10),

in which, HFOV stands for half field-of-view of the imaging lens assembly, ct1 represents thickness of the first optical lens element 510 along the optical axis (L), ct3 represents thickness of the third optical lens element 530 along the optical axis (L), T12 represents a distance between the first optical lens element 510 and the second optical lens element 520 along the optical axis (L), R1 represents a radius of curvature of the object-side surface 511 of the first optical lens element 510 near the optical axis (L), R2 represents a radius of curvature of the image-side surface 512 of the first optical lens element 510 near the optical axis (L), and f3 represents a focal length of the third optical lens element 530.

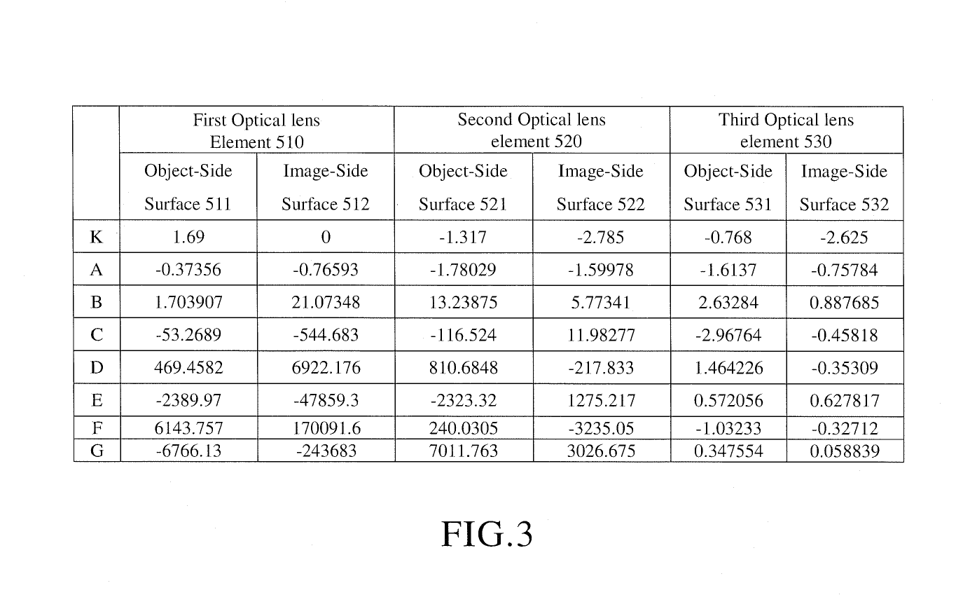

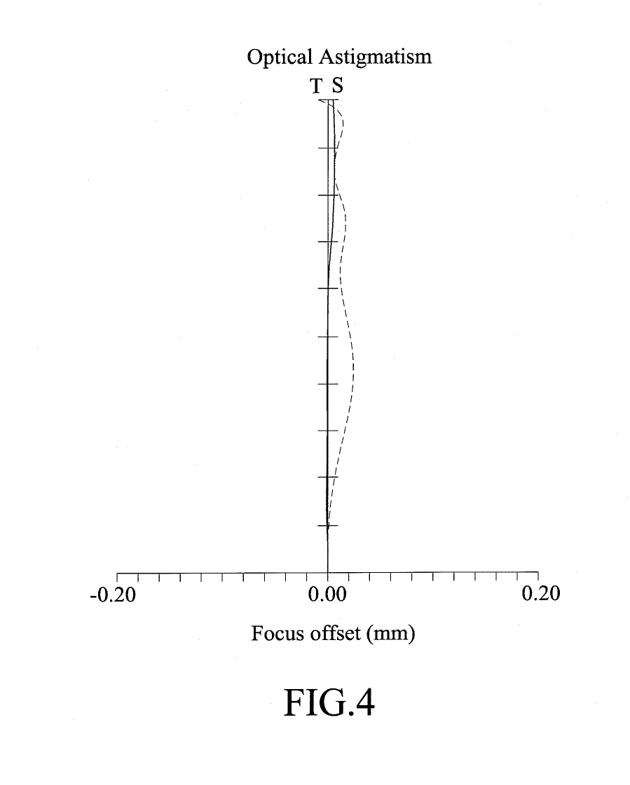

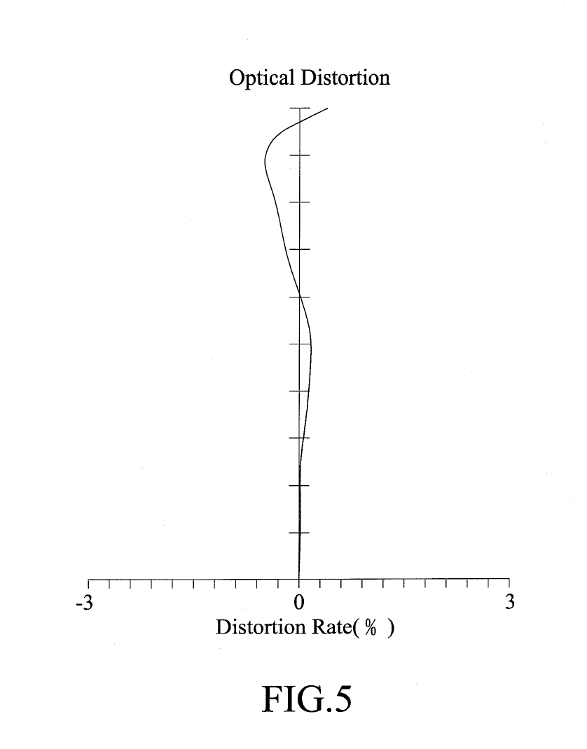

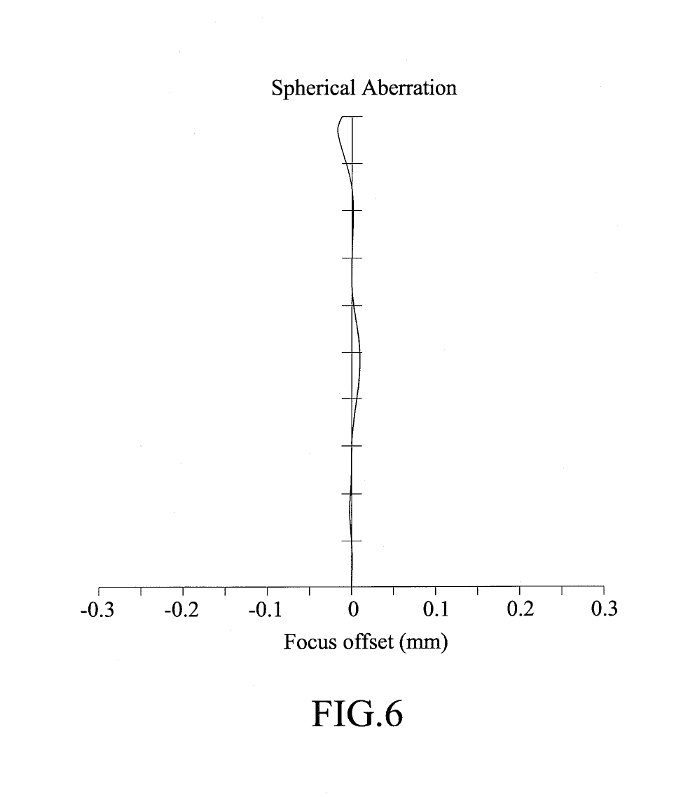

In this embodiment, each of the object-side surfaces 511, 521, 531 and the image-side surfaces 512, 522, 532 of the first, second and third optical lens elements 510, 520, 530 is aspheric. FIG. 3 shows a table of parameters for the aspheric surfaces 511, 512, 521, 522, 531, 532 of the first preferred embodiment of the imaging lens assembly according to the present invention. FIG. 4 is a simulation result of optical astigmatism of the first preferred embodiment of the imaging lens assembly based on the optical parameters of FIG. 2 according to the present invention. FIG. 5 is a simulation result of optical distortion of the first preferred embodiment of the imaging lens assembly based on the optical parameters of FIG. 2 according to the present invention. FIG. 6 is a simulation result of spherical aberration of the first preferred embodiment of the imaging lens assembly based on the optical parameters of FIG. 2 according to the present invention.

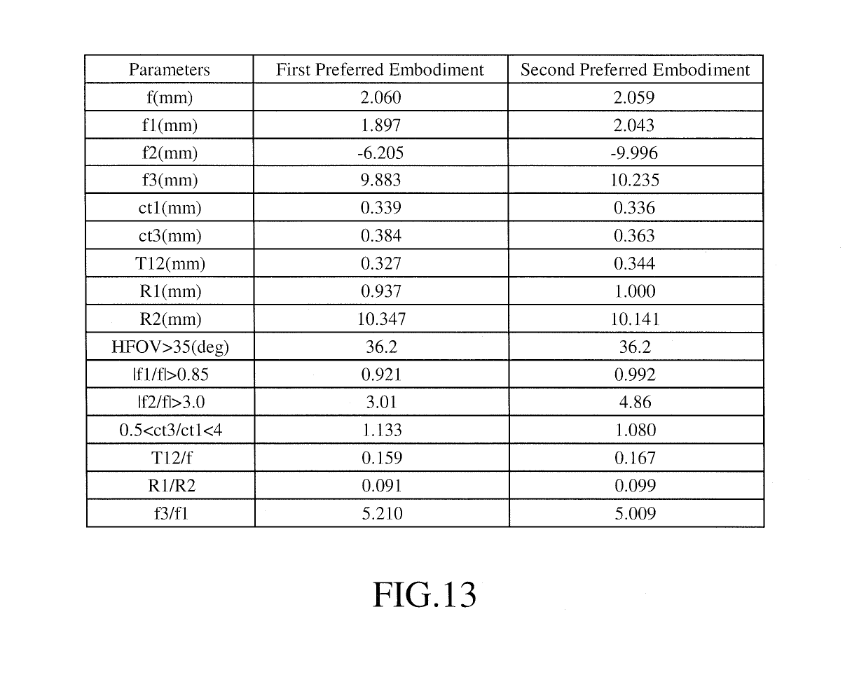

By satisfying Equation 1 (eq1), where the highest order aspheric coefficient for this preferred embodiment is 16, the first preferred embodiment of the imaging lens assembly as shown in FIG. 2 can be implemented. Moreover, the values of the optical parameters for the first preferred embodiment of the optical lens assembly as shown in FIG. 13 can be obtainable based on the parameters given in FIGS. 2 and 3 for the first preferred embodiment of the imaging lens assembly. Therefore, preferred values of optical astigmatism, optical distortion, and spherical aberration may be achievable, satisfying the Equations 2 to 10 (eq2 to eq10).

### Second Preferred Embodiment

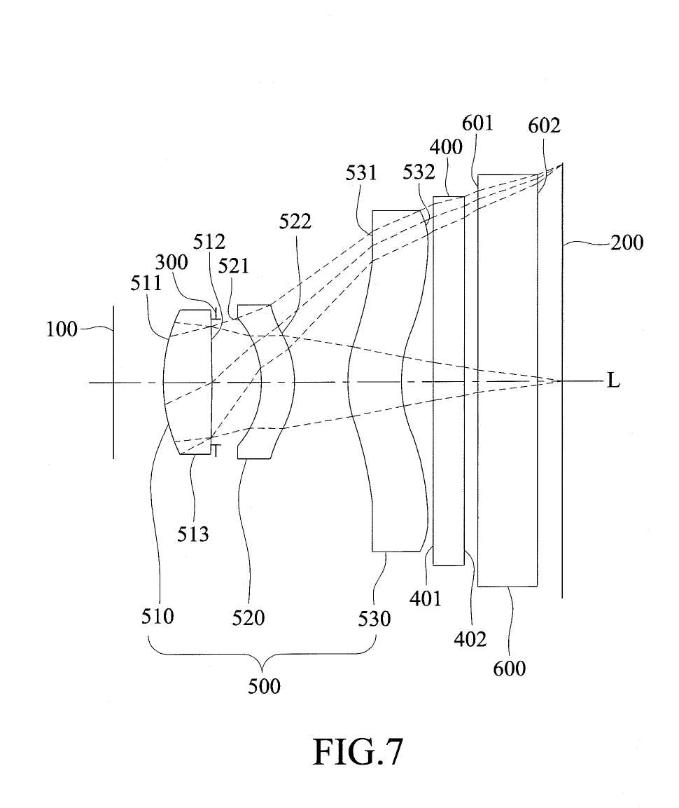

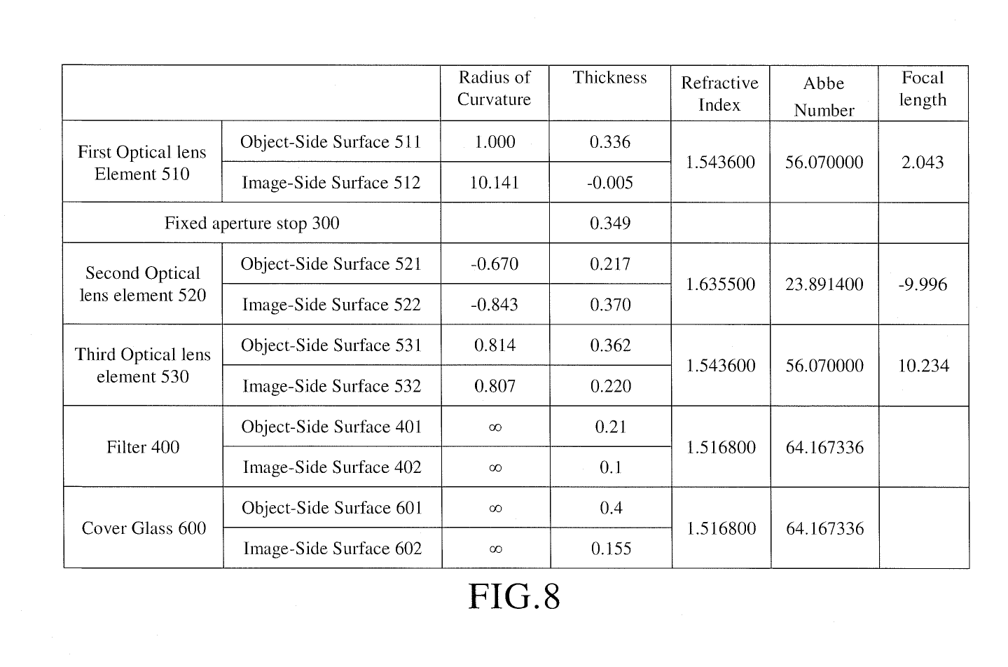

FIG. 7 is a schematic view of a second preferred embodiment of the imaging lens assembly according to the present invention. The second preferred embodiment of the imaging lens assembly is similar to the first preferred embodiment. FIG. 8 shows a table of optical parameters for first, second and third optical lens elements 510, 520, 530 of an optical lens set 500, a fixed aperture stop 300, a filter 400 and a cover glass 600 of the second preferred embodiment of the imaging lens assembly according to the present invention. The optical parameters includes radius of curvature, thickness, refractive index, Abbe number and focal length.

The first optical lens element 510 has an arched object-side surface 511 that faces the object side 100 and that has a convex segment near an optical axis (L), and an arched image-side surface 512 that faces the image side 200 and that has a concave segment near the optical segment (L) such that the first optical lens element 510 has a positive refractive power near the optical axis (L). The second optical lens element 520 has an arched object-side surface 521 that faces the object side 100 and that has a concave segment near the optical axis (L), and an arched image-side surface 522 that faces the image side 200 and that has a convex segment near the optical segment (L) such that the second optical lens element 520 has a negative refractive power near the optical axis (L). The third optical lens element 530 has an arched object-side surface 531 that faces the object side 100 and that has a convex segment near the optical axis (L), and an arched image-side surface 532 that faces the image side 200 and that has a concave segment near the optical segment (L) such that the third optical lens element 530 has a positive refractive power near the optical axis (L).

The fixed aperture stop 300 in this preferred embodiment is disposed between the first and second optical lens elements 510, 520, but may be disposed in any place between the object side 100 and the second optical lens element 520 in other embodiments of the present invention.

The image side 200 in this preferred embodiment is an image sensor, more particularly, a light sensor. The image sensor is for detection of light passing through the imaging lens assembly, and may be selected from a charge-coupled device (CCD) and a complementary metal-oxide-semiconductor (CMOS).

The cover glass 600 includes an object-side surface 601 that faces the object side 100 and an image-side surface 602 that faces the image side 200. The cover glass 600 in this preferred embodiment is a plane glass, and is disposed between the filter 400 and the image sensor (serves as the image side 200) for protection of the image sensor.

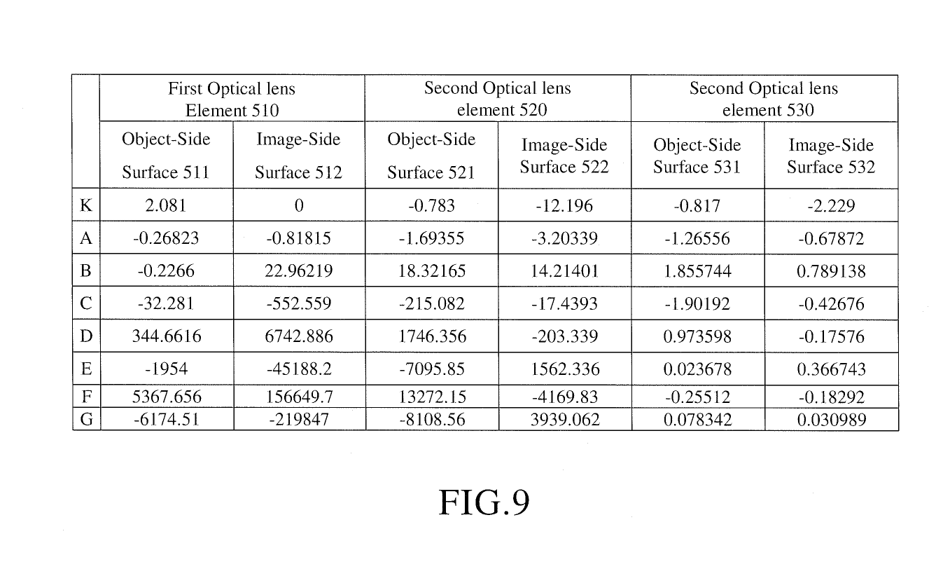

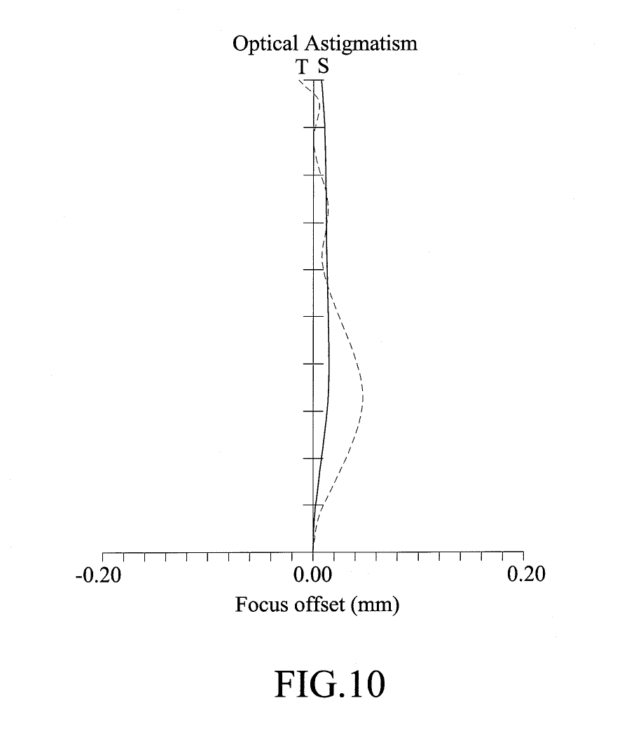

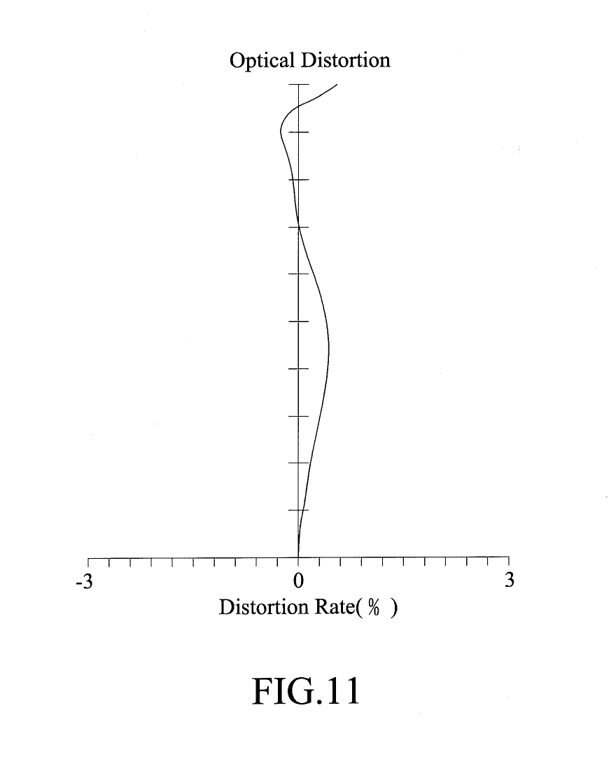

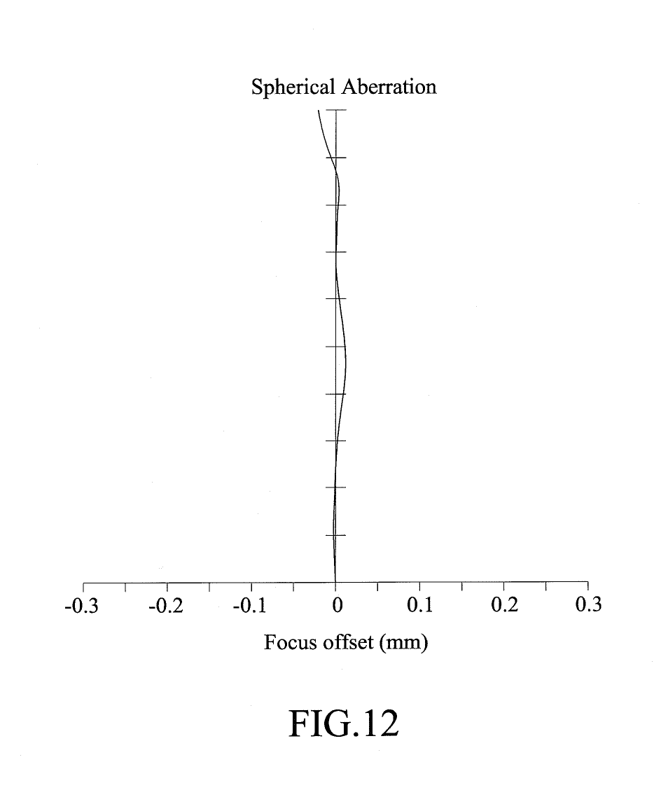

In this embodiment, each of the object-side surfaces 511, 521, 531 and the image-side surfaces 512, 522, 532 of the first, second and third optical lens elements 510, 520, 530 is aspheric. FIG. 9 shows a table of parameters for the aspheric surfaces 511, 512, 521, 522, 531, 532 of the second preferred embodiment of the imaging lens assembly according to the present invention. FIG. 10 is a simulation result of optical astigmatism of the second preferred embodiment of the imaging lens assembly based on the optical parameters of FIG. 8 according to the present invention. FIG. 11 is a simulation result of optical distortion of the second preferred embodiment of the imaging lens assembly based on the optical parameters of FIG. 8 according to the present invention. FIG. 12 is a simulation result of spherical aberration of the second preferred embodiment of the imaging lens assembly based on the optical parameters of FIG. 8 according to the pre sent invention.

By satisfying Equation 1 (eq1), where the highest order aspheric coefficient for this preferred embodiment is 16, the second preferred embodiment of the imaging lens assembly as shown in FIG. 8 can be implemented. Moreover, the values of the optical parameters for the second preferred embodiment of the optical lens assembly as shown in FIG. 13 can be obtainable based on the parameters given in FIGS. 8 and 9 for the second preferred embodiment of the imaging lens assembly. Therefore, preferred values of optical astigmatism, optical distortion, and spherical aberration maybe achievable, satisfying the Equations 2 to 10 (eq2 to eq10).

To conclude, by virtue of the imaging lens assembly of the present invention that satisfies the Equations 1 to 10 (eq1 to eq10), a resolving power of the imaging lens assembly may be increased, and the overall thickness of the imaging lens assembly may be decreased.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An imaging lens assembly, comprising:
an optical lens set including first, second and third optical lens elements that are arranged sequentially from an object side to an image side along an optical axis of said imaging lens assembly,
said first optical lens element having a positive refractive power near the optical axis, said first optical lens element having an arched object-side surface that faces the object side, and an arched image-side surface that faces the image side,
said second optical lens element having a negative refractive power near the optical axis, said second optical lens element having an arched object-side surface that faces the object side, and an arched image-side surface that faces the image side,
said third optical lens element having a positive refractive power near the optical axis, said third optical lens element having an arched object-side surface that faces the object side, and an arched image-side surface that faces the image side; and
a fixed aperture stop disposed between the object side and said second optical lens element;
wherein said imaging lens assembly satisfies the following optical conditions:

|f1/f|>0.85, and

|f2/f|>3.0
in which, f represents a focal length of said imaging lens assembly, and f1 and f2 represent focal lengths of said first optical lens element and said second optical lens element, respectively.

2. The imaging lens assembly as claimed in claim 1, wherein at least one of said object-side surfaces and said image-side surfaces of said first, second and third optical lens elements is aspheric, and satisfies the following equation:
$$z = \frac{{ch}^{2}}{1 + {[ 1 - ( k + 1 ) {c}^{2} {h}^{2} ]}^{0.5}} + A {h}^{4} + {Bh}^{6} + {Ch}^{8} + {Dh}^{10} + {Eh}^{12} + {Fh}^{14} + {Gh}^{16} + {Hh}^{18} + {Jh}^{20} + … ,$$
in which, z is the z-component of the displacement of the aspheric surface from the vertex of the aspheric surface along the optical axis, at a distance h from the optical axis; k is a conic constant; c is the reciprocal of a radius of curvature; and A, B, C, D, E, F, G, H and J, etc. are aspheric coefficients.

3. The imaging lens assembly as claimed in claim 2, wherein said object-side surface of said first optical lens element has a convex segment near the optical axis, said image-side surface of said first optical lens element having a concave segment near the optical axis,
said object-side surface of said second optical lens element having a concave segment near the optical axis,
said image-side surface of said second optical lens element having a convex segment near the optical axis, said object-side surface of said third optical lens element having a convex segment near the optical axis, and said image-side surface of said third optical lens element having a concave segment near the optical axis.

4. The imaging lens assembly as claimed in claim 1, further satisfying the following optical condition:
HFOV>35 degrees,
in which, HFOV stands for half field-of-view of said imaging lens assembly.

5. The imaging lens assembly as claimed in claim 1, further satisfying the following optical condition:
0.5<ct3/ct1<4,
in which, ct1 and ct3 represent thicknesses of said first and third optical lens elements along the optical axis, respectively.

6. The imaging lens assembly as claimed in claim 1, further satisfying the following optical conditions:
0.85<|f1/f|<1.1, and
3.0<|f2/f|<5.0.

7. The imaging lens assembly as claimed in claim 1, wherein said fixed aperture stop is disposed between said first optical lens element and said second optical lens element.

8. The imaging lens assembly as claimed in claim 2, wherein said first optical lens element further has a peripheral surface that interconnects said object-side surface and said image-side surface of said first optical lens element, and said image-side surface of said first optical lens element having at least one inflection point between the optical axis and said peripheral surface.

9. The imaging lens assembly as claimed in claim 1, further satisfying the following optical condition:
0<T12/f<1.0,
in which, T12 represents a distance between said first optical lens element and said second optical lens element along the optical axis.

10. The imaging lens assembly as claimed in claim 1, further satisfying the following optical condition:
0<R1/R2<0.5,
in which, R1 represents a radius of curvature of said object-side surface of said first optical lens element near the optical axis, and R2 represents a radius of curvature of said image-side surface of said first optical lens element near the optical axis.

11. The imaging lens assembly as claimed in claim 1, further satisfying the following optical condition:
0<f3/f1<10,
in which, f3 represents a focal length of said third optical lens element.

12. An imaging lens assembly, comprising:
an optical lens set including first, second and third optical lens elements that are arranged sequentially from an object side to an image side along an optical axis of said imaging lens assembly,
said first optical lens element having a positive refractive power near the optical axis, said first optical lens element having an arched object-side surface that faces the object side, an arched image-side surface that faces the image side and a peripheral surface that interconnects said object-side surface and said image-side surface, said image-side surface of said first optical lens element having at least one inflection point between the optical axis and said peripheral surface,
said second optical lens element having a negative refractive power near the optical axis, said second optical lens element having an arched object-side surface that faces the object side, and an arched image-side surface that faces the image side,
said third optical lens element having a positive refractive power near the optical axis, said third optical lens element having an arched object-side surface that faces the object side, and an arched image-side surface that faces the image side; and
a fixed aperture stop disposed between the object side and said second optical lens element;
wherein said imaging lens assembly satisfies the following optical conditions:

|f1/f|>0.85, and

|f2/f|>3.0
in which, f represents a focal length of said imaging lens assembly, and f1 and f2 represent focal lengths of said first optical lens element and said second optical lens element, respectively.

13. The imaging lens assembly as claimed in claim 12, further including a cover glass and a filter that are arranged sequentially from said third optical lens element to the image side along the optical axis.

14. The imaging lens assembly as claimed in claim 12, wherein said object-side surface of said first optical lens element having a convex segment near the optical axis, said image-side surface of said first optical lens element having a concave segment near the optical axis,
said object-side surface of said second optical lens element having a concave segment near the optical axis, said image-side surface of said second optical lens element having a convex segment near the optical axis,
said object-side surface of said third optical lens element having a convex segment near the optical axis, and said image-side surface of said third optical lens element having a concave segment near the optical axis.

15. The imaging lens assembly as claimed in claim 12, further satisfying the following optical conditions:
HFOV>35 degrees, and
0.5<ct3/ct1<4,
in which, HFOV stands for half field-of-view of said imaging lens assembly, and ct1 and ct3 represent thicknesses of said first and third optical lens elements along the optical axis, respectively.

16. The imaging lens assembly as claimed in claim 12, wherein said fixed aperture stop is disposed between said first optical lens element and said second optical lens element.
